(19) United States
(12) Patent Application Publication
(10) Pub. No.: US 2024/0130580 A1
(43) Pub. Date: Apr. 25, 2024

(54) CLEANING DEVICE FOR EFFICIENT REMOVAL OF CONTAMINANTS FROM HINGE HOLE

(71) Applicant: FU DING ELECTRONICAL TECHNOLOGY (JIASHAN) CO., LTD., Jiashan (CN)

(72) Inventors: WANG-BIN YI, Kunshan (CN); Xiao-Long Chen, Kunshan (CN); Yong Zhu, Kunshan (CN); Yu-Xiang Yao, Kunshan (CN); Hao Chen, Kunshan (CN)

(21) Appl. No.: 18/399,989

(22) Filed: Dec. 29, 2023

Related U.S. Application Data
(63) Continuation-in-part of application No. PCT/CN2021/133171, filed on Nov. 25, 2021.

(51) Int. Cl. A47L 5/14; A47L 9/02; A47L 9/24; A47L 9/28; B08B 9/00

(52) U.S. Cl. CPC A47L 5/14; A47L 9/02; A47L 9/24; A47L 9/2857; B08B 9/00

(57) ABSTRACT

A cleaning device includes a base, a positioning component, and a cleaning component, all mounted on the base. The positioning component includes a fixture and a side pushing member, the side pushing member located alongside the fixture. The side pushing member is used to push a workpiece into a limiting area of the fixture, where the fixture secures the workpiece in place. The cleaning component includes an exhaust member and a suction member. The exhaust member blows gas into contaminated holes, the gas is then sucked by the suction member.

### FIELD

The present disclosure generally relates to cleaning apparatus, and more particularly, to a cleaning device designed for removal of contaminants from an interior hole of a workpiece.

### BACKGROUND

An electronic device, such as a laptop computer, may have an upper cover and a lower cover rotatably connected to each other by a hinge. The upper cover or the lower cover may have a hinge hole for receiving the hinge. Before installing the hinge into the hinge hole, contaminants inside the hinge hole need to be removed, thereby avoiding poor alignment between the upper and the lower covers.

In related arts, the hinge hole is cleaned by an air blower. However, the air blower may be manually operated, and the manual operation is not only time-consuming but also lacks effectiveness. Furthermore, the manual process may cause damages to an outer surface of the upper cover, thus reducing an aesthetic quality of the final product.

### BRIEF DESCRIPTION OF THE DRAWINGS

Implementations of the present technology will now be described, by way of example only, with reference to the attached figures.

FIG. 1 is a diagrammatic view illustrating a cleaning device according to an embodiment of the present disclosure.

FIG. 2 is a partial diagrammatic view illustrating a cleaning component of the cleaning device in FIG. 1.

FIG. 3 is a cross-sectional view illustrating the cleaning component along line III-III shown in FIG. 2.

FIG. 4A is a partial diagrammatic view illustrating a first nozzle of the cleaning device in FIG. 1, wherein the first nozzle mostly extends into a hinge hole before retraction.

FIG. 4B is a partial diagrammatic view illustrating the first nozzle slightly extends into the hinge hole after retraction.

FIG. 5 is a partial diagrammatic view illustrating a positioning component of the cleaning device in FIG. 1.

FIG. 6 is a diagrammatic view illustrating a base of the cleaning device in FIG. 1 being drawn out.

### DETAILED DESCRIPTION

It will be appreciated that for simplicity and clarity of illustration, where appropriate, reference numerals have been repeated among the different figures to indicate corresponding or analogous members. In addition, numerous specific details are set forth in order to provide a thorough understanding of the embodiments described herein. However, it will be understood by those of ordinary skill in the art that the embodiments described herein can be practiced without these specific details. In other instances, methods, procedures, and members have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to;” it specifically indicates open-ended inclusion or membership in the so-described combination, group, series, and the like.

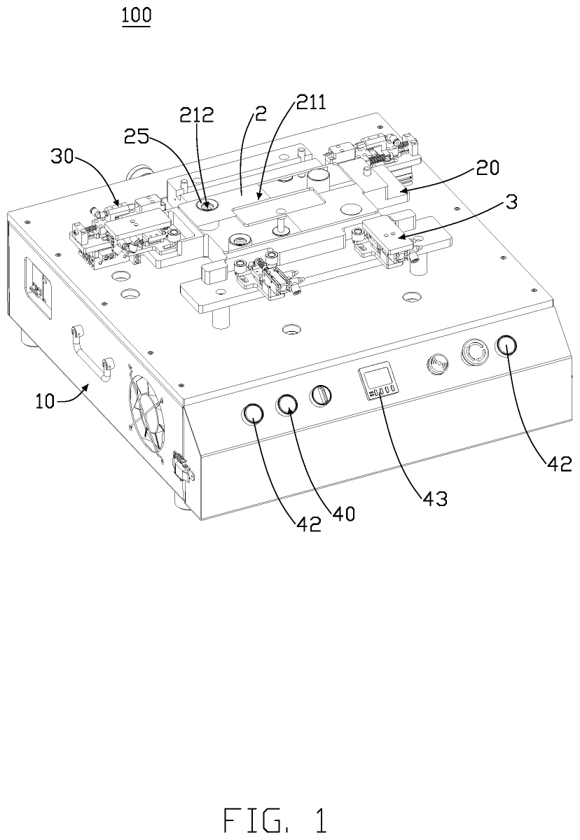

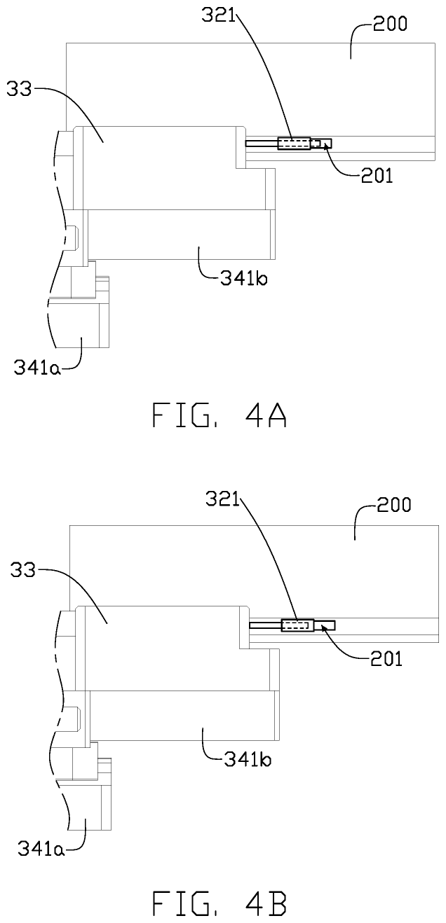

Referring to FIG. 1, a cleaning device 100 is provided according to an embodiment of the present disclosure. The cleaning device 100 may be used for cleaning contaminants such as moisture and aluminum debris in a hinge hole 201 of an upper cover 200 (FIG. 4) of a laptop computer. The cleaning device 100 includes a base 10, a positioning component 20, a cleaning component 30, and a control unit 40. The positioning component 20 and the cleaning component 30 are mounted on a surface of the base 10. The control unit 40 is housed within the base 10. The control unit 40 is electrically connected to the positioning component 20 for positioning the upper cover 200. The control unit 40 is also electrically connected to the cleaning component 30 for cleaning the hinge hole 201. In some embodiments, the cleaning device 100 may also be used to clean a casing of mobile phone, a bracket of a camera module, or any other perforated workpiece.

The cleaning device 100 provided by this application uses the positioning component 20 to position the upper cover 200. The cleaning component 30 can blow off the contaminants from the hinge hole 201, and can further suck back the above contaminants, thus cleaning the hinge hole 201. The cleaning device 100 is automatic and can reduce damages to the external surface of the upper cover 200 to improve the aesthetic quality of the upper cover 200.

Referring to FIG. 1, the positioning component 20 include a fixture 2 and a side pushing member 3. The fixture 2 has a limiting area 211. The side pushing member 3 is positioned at a side of the fixture 2. The side pushing member 3 is used to push the upper cover 200 (see FIG. 4) into the limiting area 211, and the limiting area 211 is used for positioning the upper cover 200. Thereby, it facilitates the cleaning of the hinge hole 201 (see FIG. 4) by the cleaning component 30.

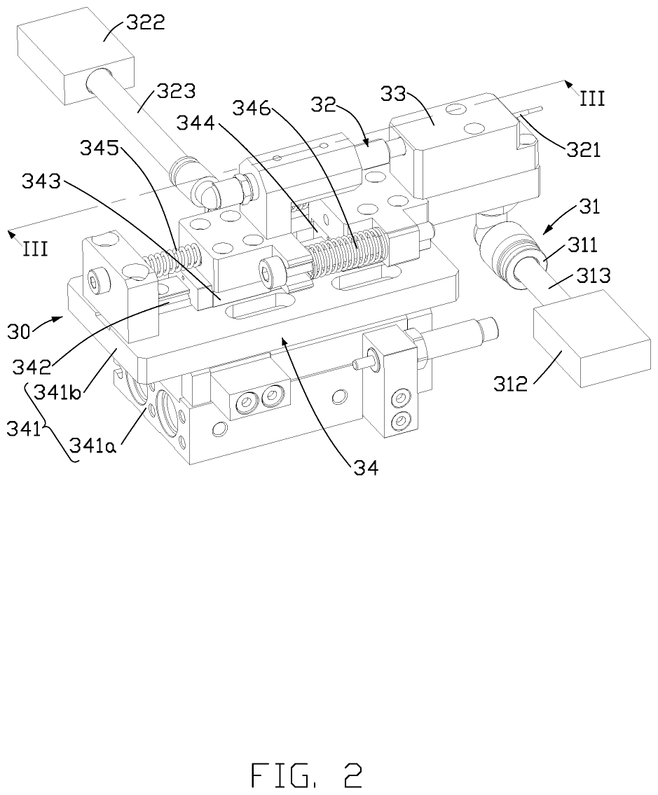

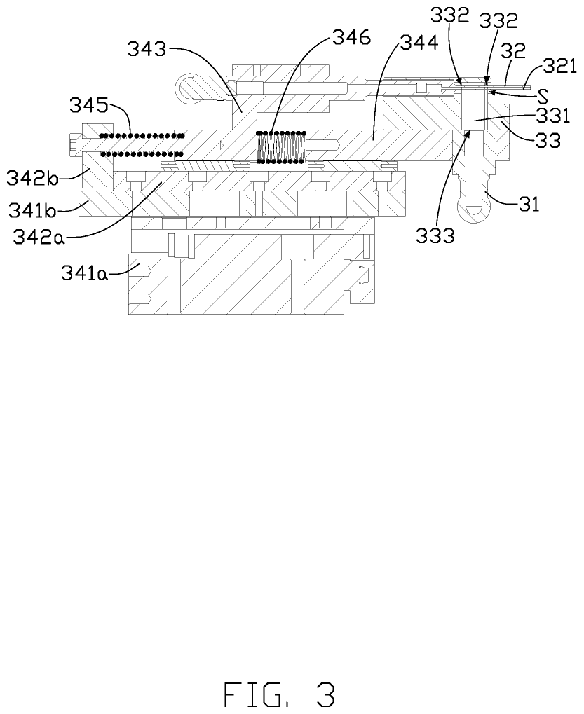

Referring to FIGS. 2 and 3, the cleaning component 30 includes a suction member 31, an exhaust member 32, and a container 33. The suction member 31 and the exhaust member 32 are both connected to the container 33. The container 33 defines an air space 331. The exhaust member 32 blows clean gas towards the hinge hole 201, allowing the clean gas to enter the hinge hole 201 and blow off the contaminants. The clean gas then becomes contaminated gas. The contaminated gas flows back into the air space 331. The suction member 31 extracts the contaminated gas from the air space 331, thus removing the contaminants from the hinge hole 201. The container 33 can receive the contaminated gas and prevent the contaminated gas from dispersing outward. In another embodiment, the container 33 may be replaced with a pipeline. In other embodiments, the container 33 may also be omitted.

Referring to FIGS. 2 and 3, in this embodiment, the cleaning component 30 also includes a driving member 34. The driving member 34 includes a first driving component 431, a first linear rail 342, a first slider 343, a second slider 344, a first elastic member 345, and two second elastic members 346.

Referring to FIGS. 2 and 3, the first driving component 431 is a slide cylinder. The first driving component 431 includes a cylinder body 341a and a slide table 341b driven by the cylinder body 341a. The cylinder body 341a is fixed on the base 10. The slide table 341b is movably mounted on a side of the cylinder body 341a away from the base 10. In some embodiments the first driving component 431 can be replaced with a motor or an internal combustion engine.

Referring to FIGS. 2 and 3. The first linear rail 342 includes a rail body 342a and a stopping block 342b disposed at one end portion of the rail body 342a. The rail body 342a is fixedly mounted on a side surface of the slide table 341b away from the base 10.

Referring to FIGS. 2 and 3, the first slider 343 and the second slider 344 are both movably mounted on the rail body 342a. The first elastic member 345 is arranged between the first slider 343 and the stopping block 342b. The two second elastic members 346 are arranged between the first slider 343 and the second slider 344. The container 33 is mounted on the second slider 344. The container 33 defines two first openings 332 and a second opening 333. The two first openings 332 are oppositely arranged, and the second opening 333 is staggered from the first openings 332. Both the first openings 332 and the second opening 333 are connected to the air space 331.

Referring to FIGS. 2 and 3, the exhaust member 32 includes a gas compressor 322, a first nozzle 321, and a first pipeline 323 connecting the gas compressor 322 and the first nozzle 321. One end portion of the first nozzle 321 is fixed to the first slider 343, and other end portion of the first nozzle 321 passes through the two first openings 332 and protrudes from the container 33. A gap S is formed between the first nozzle 321 and the first openings 332. The gas compressor 322 generates compressed clean gas, such as high-pressure nitrogen or high-pressure air. The high-pressure clean gas enters the first nozzle 321 through the first pipeline 323, and is then sprayed at high speed from the end of the first nozzle 321 into the hinge hole 201 to be cleaned, thereby becoming contaminated gas. The contaminated gas flows through the gap S into the air space 331.

Referring to FIGS. 2 and 3, the suction member 31 includes a vacuum generator 312, a second nozzle 311, and a second pipeline 313 connecting the vacuum generator 312 and the second nozzle 311. The second nozzle 311 connects to the second opening 333. The vacuum generator 312 creates a negative pressure, allowing the contaminated gas in the air space 331 to enter the second nozzle 311 through the second opening 333, then pass through the second pipeline and discharged outward. The contaminated gas may be filtered before discharged outward.

Referring also to FIGS. 3, 4A, and 4B, when in use, the cylinder body 341a drives the slide table 341b towards the fixture 2, causing the slide table 341b to move the first nozzle 321, the second nozzle 311, and the container 33 towards the fixture 2. When the first nozzle 321 extends into the hinge hole 201, the container 33 abuts against the upper cover 200 around the hinge hole 201, the gap S communicates with the hinge hole 201. Meanwhile, the first elastic member 345 and the second elastic members 346 can buffer collisions between the container 33 and the upper cover 200, reducing the occurrence of deformation or misalignment due to rigid collisions between the container 33 and the upper cover 200. The first elastic member 345 and the second elastic members 346 are compressed springs. The elastic coefficient of the first elastic member 345 is lower than the elastic coefficient of the second elastic members 346, allowing a reverse force of the gas when the first nozzle 321 sprays into the hinge hole 201 to overcome an elastic force of the first elastic member 345, causing the first nozzle 321 to retract slightly, thus enabling the first nozzle 321 to spray different areas within the hinge hole 201. The present application can clean a hinge hole 201 of step-shaped.

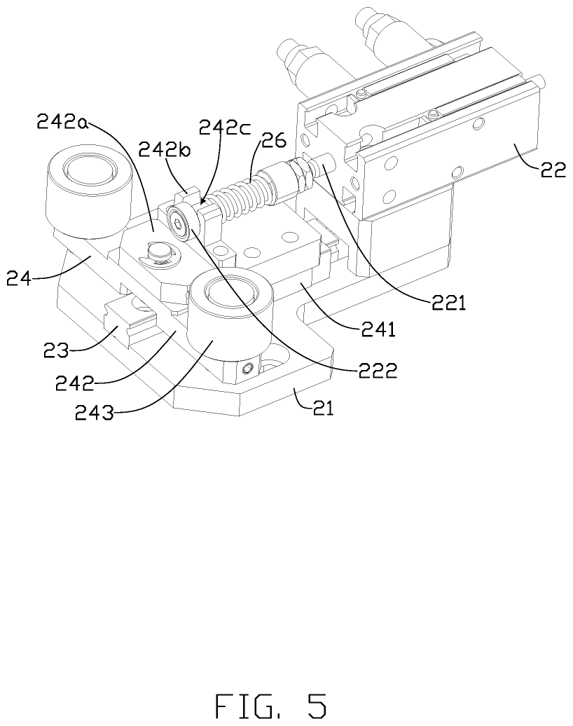

Referring to FIG. 5, in this embodiment, the side pushing member 3 includes a bottom plate 21, a second driving component 22, a second linear rail 23, and a pushing portion 24. The bottom plate 21 is positioned on one side of the fixture 2. The second driving component 22 and the second linear rail 23 is mounted on the bottom plate 21. The pushing portion 24 is movably mounted on the second linear rail 23. The second driving component 22 is connected to the pushing portion 24 to push the pushing portion 24 from the side to push the upper cover 200. The second driving component 22 is a linear cylinder. In some embodiments, the second driving component 22 can also be replaced with a motor or an internal combustion engine.

Referring to FIG. 5, in this embodiment, the pushing portion 24 includes a third slider 241, a linkage 242, and two side pushing blocks 243. The third slider 241 is slidably mounted on the second linear rail 23. The linkage 242 is mounted on the third slider 241. The side pushing blocks 243 are mounted on the linkage 242. The linkage 242 includes a linkage body 242a and a protrusion 242b mounted on the linkage body 242a. The protrusion 242b defines a groove 242c. The groove 242c penetrates two opposite surfaces of the protrusion 242b. The second driving component 22 includes an output shaft 221 and a stopping ring 222 mounted at an end portion of the output shaft 221. An end portion of the output shaft 221 is movably accommodated in the groove 242c. The stopping ring 222 abuts against the protrusion 242b, thereby ensuring stable power output and reducing stuttering.

Referring to FIG. 5, in this embodiment, the side pushing member 3 further includes a third elastic member 26. The third elastic member 26 is positioned between the linkage 242 and the output shaft 221. The third elastic member 26 serves to buffer a force exerted by the output shaft 221 onto the linkage 242.

Referring to FIG. 5, in this embodiment, the side pushing blocks 243 are symmetrically mounted at two opposite end portions of the linkage 242. Each of the side pushing blocks 243 is generally cylindrical. A curved side surface of the side pushing blocks 243 is used to push against the upper cover 200, which allows for a line contact between the side pushing blocks 243 and the upper cover 200, thereby improving a precision of the side pushing blocks 243 and reducing wear on the upper cover 200.

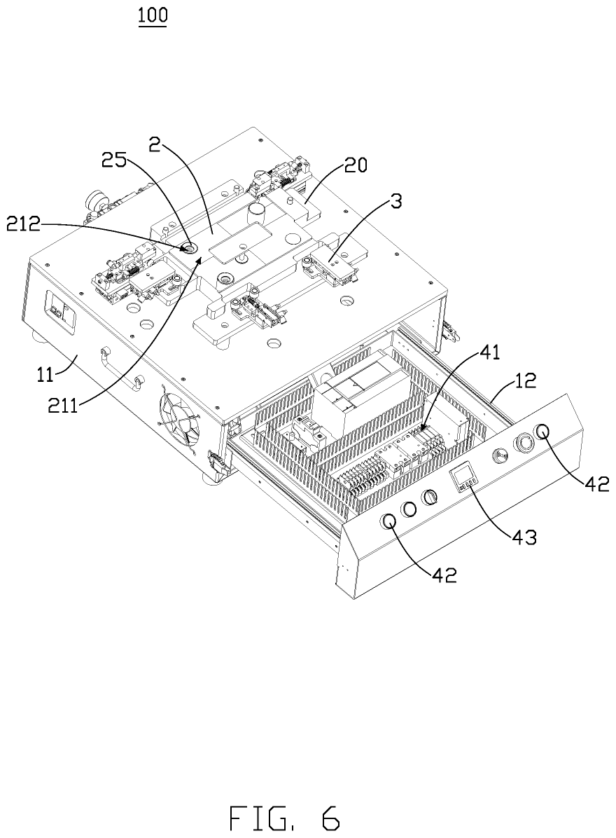

Referring to FIGS. 1 and 6, in this embodiment, the positioning component 20 further include a plurality of suction cups 25. The fixture 2 defines a plurality of through holes 212 located within the limiting area 211. The plurality of suction cups 25 are positioned within the plurality of through-holes 212. The plurality of suction cups 25 are used to adhere to and secure a bottom of the upper cover 200. This prevents movement during the air-blowing process, ensuring that the first nozzle 321 is aligned with the hinge hole 201.

Referring to FIGS. 1 and 6, in this embodiment, the base 10 is designed as a drawer structure. The base 10 includes an outer box 11 and an inner box 12. The outer box 11 is movably sleeved on the inner box 12. The positioning component 20 and the cleaning component 30 are mounted on the outer box 11. The control unit 40 is housed within the inner box 12. Such structure not only saves space but also facilitates wiring and maintenance.

Referring to FIGS. 1 and 6, in this embodiment, the control unit 40 includes a control board 41, two start buttons 42, and a timer 43. Both the start buttons 42 and the timer 43 are electrically connected to the control board 41. The two start buttons 42 are spaced from each other outside of the inner box 12. The timer 43 is positioned between the two start buttons 42. The control board 41 is also electrically connected to the positioning component and the cleaning component 30. Referring to FIGS. 1 and 2, when in use, both start buttons 42 are simultaneously pressed to control the side pushing member 3 to push the upper cover 200 to the predetermined limiting area 211. Subsequently, the first nozzle 321 blows air, with the timer 43 controlling the duration of the air blowing. When a preset time is reached, the timer 43 stops blowing air from the first nozzle 321. The two start buttons 42 require the operator to use both hands to operate, thereby increasing operational safety. The timer 43 can adjust the duration of air blowing, thereby facilitating the tuning of the cleaning device 100 to achieve optimal cleaning conditions. The control board 41 may be a Central Processing Unit (CPU) or other types of processors, such as a Digital Signal Processor (DSP) or an Application-Specific Integrated Circuit (ASIC).

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A cleaning device for cleaning contaminants inside a hole of a workpiece, comprising:
a base;
a positioning component mounted on the base; and
a cleaning component mounted on the base,
wherein the positioning component comprises a fixture, a side pushing member, an exhaust member, and a suction member, the fixture comprises a limiting area, the side pushing member is positioned at a side of the fixture, the side pushing member is configured to push the workpiece to the limiting area, the fixture is configured to secure the workpiece within the limiting area, the exhaust member is configured to blow clean gas into the hole to remove the contaminants, thereby causing the clean gas to become contaminated gas, and the suction member is configured to suck the contaminated gas.

2. The cleaning device of claim 1, wherein the cleaning component comprises a driving member, the driving member comprises a first driving component, a first linear rail, a first slider, and a second slider, the first and second sliders are movably mounted on the first linear rail, the first driving component is configured to drive the first and second sliders to move, the exhaust member is connected to the first slider, and the suction member is connected to the second slider.

3. The cleaning device of claim 2, wherein the first driving component is a slide cylinder.

4. The cleaning device of claim 3, wherein the slide cylinder comprises a cylinder body and a slide table driven by the cylinder body, the cylinder body is fixed on the base, and the slide table is movably mounted on a side of the cylinder body away from the base.

5. The cleaning device of claim 2, wherein the cleaning component further comprises a container mounted on the second slider, the container defines an air space, a first opening, and a second opening, the first opening and the second opening communicate with the air space, the exhaust member comprises an first nozzle for blowing out the clean gas, the first nozzle passes through the first opening, a gap is formed between the first opening and the first nozzle, the gap is configured to allow the contaminated gas to flow into the air space, the suction member comprises a second nozzle, the second nozzle is connected to the second opening, and the second nozzle is configured to suck the contaminated gas in the air space.

6. The cleaning device of claim 5, wherein the exhaust member further comprises a gas compressor and a first pipeline connecting the gas compressor and the first nozzle, one end portion of the first nozzle is fixed to the first slider, and another end portion of the first nozzle passes through the first opening and protrudes from the container.

7. The cleaning device of claim 5, wherein the suction member further comprises a vacuum generator and a second pipeline, and the second pipeline is connected between the vacuum generator and the second nozzle.

8. The cleaning device of claim 2, wherein the driving member further comprises a first elastic member and a second elastic member, the first linear rail comprises a rail body and a stopping block located at an end portion of the rail body, the first and second sliders are movably mounted on the rail body, the first elastic member is positioned between the first slider and the stopping block, and the second elastic member is positioned between the first and second sliders.

9. The cleaning device of claim 8, wherein an elastic coefficient of the first elastic member is lower than an elastic coefficient of the second elastic member.

10. The cleaning device of claim 9, wherein the first elastic member and the second elastic member are compressed springs.

11. The cleaning device of claim 1, wherein the side pushing member comprises a bottom plate, a second driving component, a second linear rail, and a pushing portion, the bottom plate is disposed on one side of the fixture, the second driving component and the second linear rail are mounted on the bottom plate, the pushing portion is movably mounted on the second linear rail, and the second driving component is configured to drive the pushing portion to push the workpiece.

12. The cleaning device of claim 11, wherein the second driving component is a motor.

13. The cleaning device of claim 11, wherein the pushing portion comprises a third slider, a linkage, and two side pushing blocks, the third slider is movably mounted on the second linear rail, the linkage is mounted on the third slider, the two side pushing blocks are mounted on the linkage, and the second driving component is configured to drive the linkage to push the workpiece.

14. The cleaning device of claim 13, wherein the linkage comprises a linkage body and a protrusion mounted on the linkage body, the two side pushing blocks are mounted at two opposite end portions of the linkage body, the protrusion is located between the two side pushing blocks, and the protrusion is connected to the second driving component.

15. The cleaning device of claim 14, wherein the protrusion defines a groove, the second driving component comprises an output shaft and a retaining ring mounted at an end portion of the output shaft, an end of the output shaft is movably accommodated in the groove, and the retaining ring is abutted against the protrusion.

16. The cleaning device of claim 5, wherein the positioning component further comprises a plurality of suction cups, the fixture defines a plurality of through holes located within the limiting area, the plurality of suction cups is positioned within the plurality of through holes, and the plurality of suction cups is configured to secure the workpiece.

17. The cleaning device of claim 1, wherein the base comprises an inner box and an outer box, and the inner box is separably disposed within the outer box.

18. The cleaning device of claim 17, further comprising a control unit, wherein the control unit is disposed within the inner box, the positioning component and the cleaning component are mounted on the outer box, the control unit is electrically connected to the positioning component and the cleaning component.

19. The cleaning device of claim 18, wherein the control unit comprises a control board, two start buttons, and a timer, the two start buttons and the timer are electrically connected to the control board, the two start buttons are spaced from each other outside the inner box, and the timer is positioned between the two start buttons.
